(19) United States
(12) Patent Application Publication
(10) Pub. No.: US 2025/0363068 A1
(43) Pub. Date: Nov. 27, 2025

(54) APPARATUS AND FIRST AND SECOND MANAGEMENT CONTROLLERS

(71) Applicant: Intel Corporation, Santa Clara, CA (US)

(72) Inventors: Cong ZHANG, Shanghai (CN); Liangqi ZHU, Shanghai (CN); Pei GAO, Shanghai (CN); Yue LIU, Shanghai (CN); Junyu TONG, Shanghai (CN); Tao ZHAO, Shanghai (CN); Zhonghua SUN, Shanghai (CN); Hua MA, Shanghai (CN); Yue YAO, Shanghai (CN)

(21) Appl. No.: 19/235,653

(22) Filed: Jun. 12, 2025

(30) Foreign Application Priority Data
Aug. 12, 2024 (WO) PCT/CN2024/111487

(51) Int. Cl. G06F 13/42

(52) U.S. Cl. CPC G06F 13/4221; G06F 2213/0026

(57) ABSTRACT

Provided is an apparatus comprising interface circuitry, machine-readable instructions and processing circuitry to execute the machine-readable instructions. The machine-readable instructions include instructions to receive a request to reassign a CXL device from a first host to a second host. The machine-readable instructions include instructions to transmit, to a first management controller of the first host, a request for retrieving an error record of the CXL device. The machine-readable instructions include instructions to receive, from the first management controller, the error record. The machine-readable instructions include instructions to transmit, to a second management controller of a second host, a request for storing the error record of the CXL device. The machine-readable instructions include instructions to bind the CXL device to the second host after receiving a confirmation indicating successful storing of the error record at the second host.

### Cross-Reference to Related Application

This application claims priority under 35 U.S.C. § 119(a) to International Application PCT/CN2024/111487, filed on Aug. 12, 2024, in the Chinese Receiving Office. The content of this earlier filed application is incorporated by reference herein in its entirety.

### BACKGROUND

In data center environments, high-performance computing systems may increasingly rely on disaggregated architectures and shared memory resources to maximize utilization and flexibility. Compute Express Link (CXL) may be an important interconnect standard to support these trends, enabling low-latency, coherent memory access between host processors and peripheral devices such as accelerators and memory expanders. CXL devices may be dynamically reassigned between multiple host systems. However, this dynamic reassignment may introduce a challenge for system-level reliability and fault management.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a block diagram of an example of an apparatus;

FIG. 3 illustrates a block diagram of an example of an apparatus;

FIG. 4 illustrates an example of a system;

FIG. 5 illustrates a flowchart of an example of a method;

FIG. 6 illustrates a block diagram of an example system for reassignment of a CXL device;

FIG. 7 illustrates a block diagram of an example system for reassignment of a CXL device supporting CXL Device error forwarding;

FIG. 8, broken into partial views 8-1 and 8-2, illustrates an example of a flowchart of supporting CXL Device Error Forwarding (CDEF) during reassignment of a CXL device between host;

FIG. 9 illustrates an example of a flowchart of interactions of a CXL switch during the CXL CDEF;

FIG. 10 illustrates an example of a flowchart of interactions of BMC management controllers during the CXL CDEF;

FIG. 11 illustrates an example of a flowchart of interactions system of firmware during the CXL CDEF; and

FIG. 12 illustrates an example of a block diagram of an electronic apparatus incorporating at least one electronic assembly and/or method described herein.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

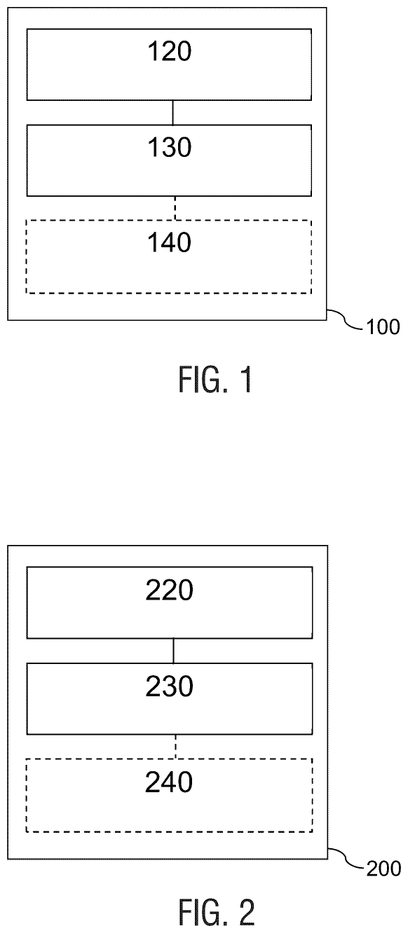

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

For example, the apparatus 100 may be part of a Compute Express Link (CXL) switch, or may be connected to a CXL switch or may implement a CXL switch. A CXL switch may be a switch for CXL devices and may be configured to facilitate the reassignment of a CXL device between a plurality of host systems. The CXL switch 100 may be physically connected to the CXL device and to a first host and a second host via one or more CXL interfaces.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the interface circuitry 120 or means for communicating 120 may correspond to one or more inputs and/or outputs for receiving and/or transmitting information, which may be in digital (bit) values according to a specified code, within a module, between modules, or between modules of different entities. For example, the interface circuitry 120 or means for communicating 120 may comprise circuitry configured to receive and/or transmit information.

For example, the interface circuitry 120 or means for communicating 120 may correspond to one or more physical and logical interfaces configured to receive and/or transmit digitally encoded information in accordance with a CXL protocol stack implemented over Peripheral Component Interconnect Express (PCIe) signaling. The interface circuitry 120 may include a plurality of physical ports supporting differential serial transmission lanes configured according to PCIe electrical specifications, and may implement link training, lane negotiation, and protocol framing to enable compliant CXL communication. The interface circuitry 120 may include a plurality of upstream ports and/or downstream ports. The upstream ports may be configured to interface with host platforms, and may be operable to receive control commands, data transfers, and coherency requests initiated by host processors. The downstream ports may be configured to interface with one or more CXL devices and may be operable to forward transaction layer packets, memory access commands, or device configuration operations from the apparatus 100 to the connected CXL devices. The upstream and downstream ports may each be associated with link controllers and internal fabric endpoints capable of interpreting CXL.io, CXL.cache, and CXL.mem protocol layers, depending on the capabilities of the attached hosts and devices.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to receive a request to reassign a CXL device from a first host to a second host. CXL may be a high-speed interconnect protocol designed to enable low-latency and memory-coherent communication between a host system and platform components, which may be referred to as CXL devices. CXL may be physically and electrically compatible with the PCI Express standard and may operate over PCIe links while implementing additional protocol layers, such as CXL.io, CXL.cache, and CXL.mem. In some examples, the CXL device may be a hardware component configured to communicate using the CXL protocol stack over a PCIe-compatible link. The CXL device may be classified according to its functional type, such as a CXL Type 1 device (for example, accelerator without memory), a CXL Type 2 device (for example an accelerator with memory), or a CXL Type 3 device (for example a memory expander or memory pooling device). A CXL device may participate in coherent transactions with a host, and may allow memory access, memory sharing, or device-specific control via CXL protocol messages. A CXL device may include circuitry to manage protocol negotiation, address decoding, and platform error reporting in conjunction with firmware or operating system software. For example, the CXL device may be a high-bandwidth memory module that enables dynamic memory pooling across multiple hosts, a GPU-like accelerator designed for Al workloads with local memory accessed over CXL.mem, or a smart network interface card with integrated compute and caching capabilities operating under CXL.cache. A CXL device may be reassignable from the first host to the second host using a CXL switch (for example apparatus 100), and may maintain platform state or error information in firmware-managed memory.

For example, each of the first and second host may be a computing system or processing platform configured to interface with one or more CXL devices via a CXL-compatible interconnect. The first and second host may include one or more processors capable of initiating CXL transactions and may act as a coherent initiator in a memory-consistent environment. In some examples, the first and second host may include a system-on-chip (SoC), server processor, or central processing unit connected to the CXL switch through one or more CXL-compatible physical links. The firs first and second host may execute firmware and operating system software to manage device resources and respond to hardware errors. The first and second host may be associated with a management controller that performs out-of-band control tasks and may expose interfaces to receive error records or respond to device reassignment instructions issued by a CXL switching apparatus. The first and second host may also support runtime firmware services, such as UEFI, to access firmware-managed storage or respond to error retrieval requests. For example, the first and second host may be a server node in a data center configured to share memory expansion devices or accelerators via a CXL fabric.

The apparatus 100 may be physically connected to the first and the second host and the ot the CXL device, for example via the interface circuitry 120. For example, the apparatus 100 may be configured to maintain physical connectivity to both the first host and the second host through upstream interfaces, and to the CXL device through a downstream interface, which may be implemented via CXL-compatible physical links.

In some examples, the processing circuitry 130 may receive the request to reassign the CXL device from an external control entity such as an orchestration controller, a management processor, or a system-level resource scheduler or the like. The request may be received over a management network, through an out-of-band interface, or via a protocol-specific control channel configured for platform-level communication. The request to reassign may include parameters identifying the CXL device, the currently bound first host, and the intended second host. For example, the request to reassign may trigger further actions.

In some examples, the processing circuitry 130 may be configured to establish a logical assignment between the first host and the CXL device. Logically assigning the first host to the CXL device may also be referred to as binding or logically connecting. The logical assignment may comprise establishing a logical connection that enables the first host system to recognize, enumerate, and access the CXL device over an existing physical link. The processing circuitry 130 may be configured to configure a control structure within the CXL switch, such as an internal table or programmable routing element, that routes all communication between the first host and the CXL device. The assignment may comprise configuring a reconfigurable interconnect element within the CXL switch, the reconfigurable interconnect element being configured to map a downstream interface associated with the CXL device to an upstream interface associated with the host. For example, the processing circuitry 130 may be configured to implement this mapping through a reconfigurable virtual PCI-to-PCI bridge (VPPB), which may function as a logical conduit for device enumeration and protocol-level communication. The VPPB may enable the host to identify the CXL device within its PCIe hierarchy and to initiate transactions using CXL protocols such as CXL.io, CXL.mem, or CXL.cache. As described above, the physical links between the host and the CXL device may already be present and active, but the CXL device may remain logically disconnected until the reconfigurable interconnect element has established a valid routing configuration. That is, in some examples, the processing circuitry 130 may instantiate the VPPB between the relevant upstream and downstream ports of the CXL switch, allowing the CXL device to respond to configuration cycles, memory-mapped I/O commands, or memory access operations issued by the host. The logical assignment may further comprise updating system-level attributes such as address decoding schemes, access control policies, and error-handling paths within the switch, thereby ensuring that the assigned host has exclusive runtime access to the CXL device. The logical assignment may thus define host-device exclusivity within a physically shared topology, permitting concurrent but isolated connectivity for multiple hosts through dynamically reconfigurable routing logic.

In some examples, the processing circuitry 130 may be further configured to unbind the CXL device from the first host. For example, unbinding the CXL device from the first host may be a part of reassigning the CXL device. In some examples, reassigning the CXL device from the first host to the second host may comprise modifying the logical assignment from the first host to the second host via a reconfigurable interconnect element. For example, reassigning the CXL device from the first host to the second host may comprise modifying the logical association by unbinding (logically disconnecting) the CXL device from the first host and binding (logically connecting) the CXL device to the second host. The unbinding and binding operations may be implemented by VPPB as reconfigurable interconnect element. For example, the reassignment may comprise disabling the VPPB or removing a routing entry that connects the CXL device to the first host, and by establishing a new VPPB or routing path between the CXL device and the second host. The reassignment may preserve the physical connectivity of the CXL device while dynamically transferring logical ownership between the first and the second host, thereby maintaining memory isolation, coherency enforcement, and awareness of platform error context across system boundaries.

The processing circuitry 130 is further configured to transmit a request for retrieving an error record of the CXL device to a first management controller of the first host. In some examples, the error record may comprise information identifying a fault condition of the CXL device. The fault condition may have occurred while the CXL device was bound to the first host. For example, the error record may be a structured data object that contains diagnostic and status information associated with one or more faults or abnormal conditions detected by a CXL device. The error record may be generated by the first host when the CXL device encounters a platform-reported hardware failure, such as a memory access violation, protocol layer malfunction, parity error, or internal device fault. The error record may encapsulate metadata identifying the type of error, the timestamp, the affected subsystem, severity classification (e.g., corrected, recoverable, or uncorrectable), and other context-specific data useful for fault isolation, recovery, or post-mortem analysis.

In some examples, the CXL device may report an error to the first host system using platform-level notification mechanisms, such as a Vendor Defined Message (VDM), SCI/SMI interrupt, or firmware-executed handler path. The first host may then invoke firmware routines (such as a platform runtime handler) to collect the error data and generate and store it in a persistent format. In some examples, the error record may be formatted and stored according to a Common Platform Error Record (CPER) specification. The error record may serve as a trusted diagnostic history and may be essential for maintaining platform reliability, availability, and serviceability (RAS), especially in enterprise and cloud environments.

For example, the first management controller (and also the second management controller, see below) may be a system-level control component configured to perform platform management, monitoring, and coordination tasks independently of the operating system or main processing cores of the first host. The first management controller may operate in an out-of-band manner and may be responsible for receiving and executing control requests related to platform configuration, firmware routines, error handling, and device management. In some examples, the first management controller may be implemented as a dedicated embedded controller, such as a Baseboard Management Controller (BMC), which may be connected to the host's firmware and hardware subsystems via internal buses or out-of-band communication channels. The first management controller may have privileged access to trigger firmware handlers, read or write to firmware-managed memory regions, and report platform status to external entities. For example, the first management controller may be a BMC embedded in the server motherboard of the first host, and may respond to the request from the apparatus 100 to fetch an error record stored during the first host's previous ownership of the CXL device. For example, the request for retrieving the error record may be a control message transmitted from the apparatus 100 to the first management controller instructing the first management controller to initiate a routine on the first host to obtaining the stored error record.

In some examples, the error record is retrieved by the first management controller by triggering a firmware handler of the first host. Upon receiving the request from the apparatus 100 to retrieve the error record associated with the CXL device, the first management controller may be configured to initiate execution of a platform-level firmware routine on the host system. This triggering may be implemented via a general-purpose input/output (GPIO) interface, a system management interrupt (SMI), or through an out-of-band communication channel such as IPMI or Redfish, depending on system configuration. The firmware handler may be a platform runtime handler or system management routine configured to execute within a privileged firmware environment, such as UEFI runtime services or System Management Mode (SMM). The firmware handler may be configured to locate and retrieve the stored error record from a firmware-managed memory region of the first host based on an identifier of the CXL device, for example a bus-device-function (BDF) address.

For example, firmware handler may be a platform runtime handler, such as PRM_handler( ) which may be executed in response to the trigger issued by the first management controller. The PRM_handler( ) may retrieve the error record stored in a firmware-managed memory region labeled NVRAM0, using the BDF address of the CXL device as a lookup key. The retrieved error record may be formatted according to a Common Platform Error Record (CPER) structure and transmitted back to the first management controller. The first management controller may then forward the error record to the apparatus 100 for subsequent transfer to the second host.

For example, the error record may be stored in a firmware-managed memory of the first host. For example, the firmware-managed memory may be a non-volatile memory (NVM) region that is controlled by the platform firmware rather than the operating system. The firmware-managed memory may be used to store diagnostic data, such as error records, in a persistent and secure manner. In some examples, the firmware-managed memory may be a non-volatile random-access memory (NVRAM) or may be part of an electrically erasable programmable read-only memory (EEPROM), which may be accessible to platform firmware during runtime or boot services. This memory may be addressable through firmware runtime services and may retain its contents across power cycles, system reboots, or device reassignments, ensuring that platform-level error information remains available even after the CXL device is unbound from the host.

In some examples, the error record may be retrieved from a non-volatile memory (NVM) of the first host using UEFI runtime services. UEFI runtime services may provide firmware-executed functions that remain accessible during the operating system runtime phase and allow platform software or privileged handlers to access firmware-managed variables and data structures. In some examples, the UEFI runtime services may include a set of callable routines exposed by the host firmware, enabling retrieval of system variables, configuration data, or diagnostic records such as error logs. The non-volatile firmware-managed memory may be under the control of the firmware, for example as a UEFI variable formatted according to the CPER specification. Upon receiving a request from the management controller, the host system may execute a runtime handler that invokes the appropriate UEFI service to read the error record from the designated storage location. This mechanism may enable secure and reliable access to the error record, even after the first host operating system has booted or if the CXL device has already been unbound from the host. By retrieving the error record using UEFI runtime services, the system ensures that the error record originates from trusted firmware-managed storage and reflects the first host's most recently recorded fault information.

In some examples, the processing circuitry 130 may be further configured to unbind the CXL device from the first host as described above. The request for retrieving the error record of the CXL device may be transmitted to the first management controller of the first host after unbinding the CXL device. In some examples, unbinding the CXL device from the first host prior to transmitting the request to retrieve the error record may provide architectural and reliability advantages during CXL device reassignment. Unbinding the CXL device may involve deactivating the logical association (such as by disabling a virtual PCI-to-PCI bridge) thereby removing the CXL device from the enumeration domain and direct runtime access of the first host. By completing this unbinding step before transmitting the request to the first management controller, the processing circuitry 130 may ensure that the first host is no longer able to perform transactions to the CXL device, thereby reducing the risk of unintended access, resource conflicts, or stale error propagation during the reassignment process.

Furthermore, transmitting the error record retrieval request only after unbinding may reflect a clean handoff point in the platform's control flow, ensuring that the error record represents the final known fault state while the device was still under management by the first host. This separation between logical disconnection and error retrieval may also align with fault containment policies, allowing the host firmware to report platform errors in a quiescent state, free from interference by pending I/O or memory operations. As a result, the reassignment process becomes more deterministic and less error-prone, particularly in environments with strict fault isolation and device lifecycle requirements.

The processing circuitry 130 is further configured to receive the error record from the first management controller. For example, the first management controller may transmit the error record to the processing circuitry 130 after retrieving it from the NVM of the first host using a firmware routine.

In some examples, the request to retrieve the error record may be transmitted from the processing circuitry 130 to the first management controller via an out-of-band network. In some examples, the first management controller may transmit the error record to the processing circuitry 130 via the out-of-band network. The out-of-band network may be a communication link between the apparatus 100 and the first management controller of the first host (or the second management controller of the second host) and may be separate from a data network of the first host (second host). That is, the out-of-band network may be physically or logically separated from the data network and may be configured for platform-level communication between the apparatus 100 and the host's management controller independently of the operating system of the host. The out-of-band network may comprise a dedicated communication path reserved for control and management traffic, for example operating through a BMC interface. For example, the out-of-band network may be implemented using a physically isolated Ethernet link, a dedicated VLAN, or a serial management interface that bypasses the primary system interconnects and provides continuous availability regardless of the operational state of the host's main processors.

The data network of the first host (or second host) may refer to the standard data communication infrastructure used by the first host to exchange application-level information, user traffic, or inter-device I/O transactions. The data network may include PCIe-based connections, internal memory fabrics, and host-controlled network interfaces such as Ethernet or InfiniBand. During normal operation, the data network may handle high-bandwidth interactions with CXL devices, including memory access, accelerator communication, and cache-coherent transactions. However, the data network may become unavailable or unreliable if the host operating system is not active, if the host is in a pre-boot or failure state, or if the CXL device has already been logically unbound. The out-of-band network ensures that management and diagnostic communications can proceed under such conditions.

The processing circuitry 130 is further configured to transmit a request for storing the error record of the CXL device to a second management controller of a second host. The second management controller may be configured in a manner similar to the first management controller described above and may be operable to receive out-of-band instructions for performing platform-level tasks independently of the operating system of the second host. The transmission of the storing request may occur via an out-of-band network that connects the switching apparatus to the second management controller and may be physically or logically separated from the data network of the second host.

The storing request transmitted to the second management controller may include the error record retrieved from the first host and may instruct the second management controller to store the error record. In some examples, request for storing the error record of the CXL device may comprise a request to store the error record in a firmware-managed storage of the second host. For example, the storing request may cause the second management controller to invoke a firmware routine that writes the error record to firmware-managed storage, such as non-volatile memory accessible through platform firmware runtime services. This may ensure that the fault information associated with the CXL device is available locally to the second host before the device is logically bound and becomes operational in its context. By storing the error record in firmware-managed storage of the second host, the second host is enabled to access trusted diagnostic information related to the CXL device's prior usage state. This allows platform-level fault handling routines, such as Reliability, Availability, and Serviceability (RAS) flows, to assess the device's health status before making it available to system software or applications. It also ensures continuity of fault awareness across host transitions, without relying on the CXL device to maintain any local error state.

The processing circuitry 130 is further configured to bind the CXL device to the second host after receiving a confirmation indicating successful storing of the error record at the second host. The confirmation indicating successful storing of the error record may serve as a condition for initiating the binding process. In some examples, the confirmation indicating successful storage of the error record may be received from the second management controller of the second host. It may indicate that the second host has accepted and persistently stored the error record, for example in firmware-managed memory. This confirmation may be transmitted over the same out-of-band network used for management communications between the apparatus 100 and the second management controller. By waiting for such confirmation, the apparatus 100 ensures that the second host has access to critical diagnostic context associated with the CXL device before the device becomes operational within the second host's system domain.

Binding the CXL device to the second host may comprise establishing a new logical assignment between the CXL device and the second platform. The assigning of the CXL device to the second host may be part of the reassignment process. The binding of the CXL device to the second host may comprise configuring an internal routing within the CXL switch as described above. For example, this may comprise instantiating a virtual PCI-to-PCI bridge (VPPB) between a downstream port associated with the CXL device and an upstream port associated with the second host. The binding may further comprise updating address mappings, enabling device enumeration, and allowing memory and I/O transactions to flow between the second host and the device in accordance with supported CXL protocols. Although the physical link between the CXL device and the second host may already exist, the CXL device may remain logically disconnected or non-operational until the binding is performed.

For example, when the CXL device is reassigned from the first host to the second host, the CXL device itself may retain no local record of its fault history and corresponding error records. If the processing circuitry assigns the CXL device to the second host without forwarding the previously stored error record, the new host may treat the device as error-free, potentially skipping RAS flows such as validation, quarantine, or deallocation. The above-described apparatus 100 may provide a robust and structured mechanism for preserving fault awareness when the CXL device is reassigned between the first and the second host. By retrieving the error record associated with the CXL device from the first host and storing it at the second host prior to binding the device, the apparatus enables seamless fault context transfer across host boundaries. The architecture allows apparatus 100 to manage device binding only after receiving confirmation that the fault data has been securely stored at the destination host, enabling controlled transitions without data loss or fault misclassification. By retrieving the error record from the first host's management controller and forwarding it to the second host before rebinding, the apparatus 100 ensures that fault awareness and safety procedures are preserved across dynamic reassignments. This allows the second host to make informed decisions about device health, usage restrictions, or additional diagnostics, thereby avoiding silent failures or repeated crashes.

The apparatus 100 of FIG. 1 also works and is disclosed and applicable to scenarios beyond Compute Express Link (CXL)-based device switching. For example, the apparatus 100 may be configured to support fault continuity and diagnostic error forwarding in systems involving other types of platform components that are reassigned or reused across host boundaries. In such systems, hardware devices—such as memory modules, accelerators, or storage controllers—may experience partial failures or degradation while assigned to a first host, resulting in error records stored by the host platform. When these components are reassigned to a second host, the second host may be unaware of the device's prior fault state in the absence of an error transfer mechanism. The apparatus 100 may be used to retrieve, transfer, and coordinate such error information across management controllers and firmware contexts, ensuring that a reassigned device is accompanied by its associated fault history. This enables the second host to make informed RAS decisions and avoid unnecessary resource deallocation or undetected failure propagation, even outside the specific context of CXL interconnects.

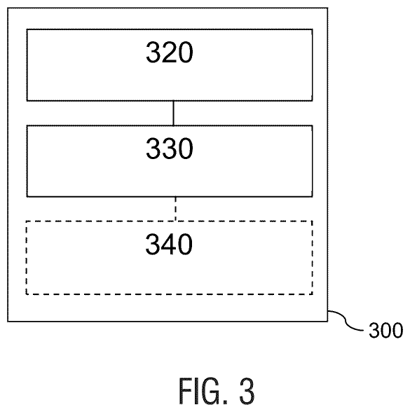

Further details and aspects are mentioned in connection with the examples below. The example shown in FIG. 1 may include one or more optional additional features corresponding to one or more aspects mentioned in connection with the proposed concept or one or more examples below (e.g., FIGS. 2-12).

FIG. 2 illustrates a block diagram of an example of a management controller 200 or device 200. The management controller 200 comprises circuitry that is configured to provide the functionality of the management controller 200. For example, the management controller 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the management controller 200, in conjunction with the interface circuitry 220. For example, the interface circuitry 220 is configured to exchange information, for example, with other components inside or outside the management controller 200 and the storage circuitry 240. Likewise, the device 200 may comprise means that is/are configured to provide the functionality of the device 200.

The components of the device 200 are defined as component means, which may correspond to, or be implemented by, the respective structural components of the management controller 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the management controller 200. Features described in connection with the management controller 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The management controller 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to receive from a CXL switch, a request to retrieve an error record of a CXL device unbound from a host corresponding to the management controller. The management controller may be part of the host. In some examples, the management controller 200 may be a control component of the host, where the host is configured to interface with the CXL device. The management controller may be implemented as a hardware-based subsystem, such as a BMC, or as a functionally equivalent system control module embedded on the host. The management controller may operate independently of the host's operating system and main processor cores, and may be configured to perform platform-level functions such as initiating firmware routines, retrieving and storing diagnostic data, or handling out-of-band communication. The management controller 200 may be the first management controller of the first host as described above with regards to FIG. 1

For example, the host may be a computing system or processing platform configured to interface with one or more CXL devices via a CXL-compatible interconnect. The host system associated with the management controller may include processing circuitry, memory resources, platform firmware, and one or more CXL interfaces. The host may be operable to bind to and interact with a CXL device via a CXL switch (for example, the apparatus 100 as described with regards to FIG. 1). The CXL switch may comprise interface circuitry configured to maintain physical and logical connectivity with the CXL device and with a plurality of hosts, including the host corresponding to the management controller. The switch may manage the reassignment of the CXL device between the host and another host, and may initiate coordination steps such as requesting retrieval of an error record from the host before assigning the CXL device to the second host.

The received request may be a control instruction and may instruct the management controller 200 to initiate the retrieval of diagnostic information associated with the CXL device. The request may be received as part of a coordinated reassignment process, in which the CXL device is being transferred from the host to another second host. The request may identify the CXL device by parameters such as a Bus-Device-Function (BDF) address or device ID and may trigger actions necessary to obtain platform-level error context prior to rebinding the device to a different host.

The CXL device may be physically connected host. However, the CXL switch may have unbound the CXL device from the host. Unbinding the CXL device from the host may refer to the logical disconnection of the CXL device from the host. Unbinding may comprise modifying or removing an internal routing structure or a reconfigurable interconnect element, such as a virtual PCI-to-PCI bridge (VPPB), which had previously established a logical communication path between the host and the CXL device within the switching fabric. Although the physical links between the host and the device may remain active, the logical assignment may be revoked, rendering the CXL device inaccessible to the host's software stack and preventing further runtime transactions. Unbinding the CXL device from the host may thus provide a clean boundary for collecting and preserving diagnostic state information, as the host no longer holds control over the device.

For example, the unbinding of the CXL device from the host may have been performed by the CXL switch just before the CXL switch may transit the request to retrieve the error record from the management controller. Receiving the request to retrieve the error record after unbinding ensures that the error context reflects the final operational state of the CXL device while under the ownership of the host. For example, as part of the reassignment process, the switch may retrieve the error record and forward it to a management controller of another host before binding the CXL device anew. This may enable the other host to inherit fault awareness, execute reliability and serviceability procedures, and ensure safe device operation following the transfer.

The processing circuitry 230 is further configured trigger a firmware routine of the host, the firmware routine being configured to obtain the error record of the CXL device. Triggering the firmware routine may be performed in response to receiving the request from the CXL switch instructing the management controller to retrieve the stored error record associated with the CXL device. The firmware routine may be a platform-level execution path capable of operating independently of the host operating system and may be invoked via mechanisms that bypass the standard software stack.

For example, the management controller may initiate the execution of the firmware routine through a system-level signaling interface. In some examples, triggering the firmware routine may comprise transmitting a trigger signal via a general-purpose input/output (GPIO) interface or a system management interrupt (SMI) to cause the host system to initiate the firmware routine.

In some examples, the firmware routine may comprise a platform runtime handler configured to use platform firmware runtime service to retrieve the error record from the firmware-managed storage. The platform runtime handler may reside in the system firmware of the host. In some implementations, the firmware routine may correspond to a handler such as PRM_handler( ) This handler may execute within a firmware-executed context such as UEFI runtime services or System Management Mode (SMM), enabling access to secure and persistent memory regions under firmware control.

The firmware routine may be specifically configured to locate, retrieve, and format the error record stored during the operational period in which the CXL device was bound to the host. For example, the firmware routine may use an identifier such as the CXL device' Bus-Device-Function (BDF) address to access a firmware-managed memory location. The retrieved error record may be structured according to a specification such as the Common Platform Error Record (CPER) format and may include metadata indicating the nature of the fault, severity, affected subsystem, and other relevant diagnostic parameters. By triggering the firmware routine, the management controller ensures that the error record is collected from a trusted source and reflects an accurate snapshot of the device' last known fault state under the host.

In some examples, the error record may be a structured data object comprising diagnostic information related to a fault condition of the CXL device that occurred while the device was bound to the host system. The error record may include metadata such as the fault type, timestamp, severity classification (e.g., corrected, recoverable, or fatal), affected component, and other context necessary for system-level error diagnosis and handling. The generation of the error record may be triggered by the detection of a hardware or protocol-level fault by the host system in response to error signaling from the CXL device, such as through a Vendor Defined Message (VDM), System Management Interrupt (SMI), or PCIe Advanced Error Reporting (AER) event.

The error record may be retrieved by the management controller from the host system's firmware environment using the platform firmware routine. Once retrieved by the firmware routine, the error record may be transmitted to the management controller using a communication channel that operates independently of the host operating system. In some examples, the error record is received from the firmware routine via an Intelligent Platform Management Interface (IPMI) communication channel. The IPMI channel may provide a standardized interface for system management operations and may allow the management controller to access platform data securely and reliably, even if the host system is not operational or is in a pre-boot state.

In some examples, the error record is formatted according to a Common Platform Error Record (CPER) specification. The CPER format is a standardized data structure defined in the UEFI specification and is used to record hardware error information in a consistent manner across platform components. The CPER-formatted error record may comprise fields for section descriptors, error source identifiers, severity levels, and specific hardware error data. This structured format allows downstream components—such as another host system, a system administrator, or a reliability analysis engine—to interpret and respond to the error with minimal ambiguity.

In some examples, the error record is stored in non-volatile memory managed by firmware of the host system and accessible via a firmware runtime interface. The firmware-managed memory may be distinct from general-purpose storage accessible by the host operating system and may be preserved across reboots or power cycles. In particular, the firmware-managed memory may be implemented using technologies such as non-volatile random-access memory (NVRAM) or may be part of an electrically erasable programmable read-only memory (EEPROM). These storage regions may be accessed via a firmware runtime interface, such as UEFI runtime services, and may be protected from modification or deletion by non-privileged software. The use of firmware-managed storage ensures that the error record remains persistent and trustworthy throughout the reassignment of the CXL device, enabling accurate diagnostic continuity for the receiving system.

The processing circuitry 230 may be further configured to receive the error record from the firmware routine. For example, the processing circuitry 230 of the management controller may be configured to receive the error record from the firmware routine of the host system after the firmware routine has successfully retrieved and formatted the error data. The firmware routine (for example, triggered earlier by the management controller) may execute within a privileged execution environment such as UEFI runtime or System Management Mode (SMM) and may access a firmware-managed memory region containing the persisted error record related to the CXL device. Upon successful access, the firmware routine may transmit the retrieved error record to the management controller. This transmission may be implemented using a platform-level communication interface, such as the Intelligent Platform Management Interface (IPMI), which allows structured and secure exchange of system management information independently of the host's main operating system. The IPMI interface ensures that the error record can be reliably delivered to the management controller even if the host is in a degraded or non-operational state.

By receiving the error record directly from the firmware routine, the management controller obtains a complete and up-to-date representation of the fault condition experienced by the CXL device during its previous assignment to the host. This capability may enable the controller to forward the error record to an external CXL switch or other orchestration component in support of reassignment workflows that require fault continuity and awareness across host boundaries.

The processing circuitry 230 is further configured to transmit the error record to a CXL switch. For example, this may be done following successful retrieval from the host's firmware routine. For example, transmission may be performed after the management controller has verified the integrity and completeness of the error record, and may involve encapsulating the error data in a platform-level communication message suitable for out-of-band transport. The CXL switch, which may be connected to both the host system and the CXL device, may require the error record to complete a reassignment operation of the CXL device from the first host to a second host. By forwarding the error record, the management controller enables the switch to preserve platform-level fault awareness and maintain continuity of reliability, availability, and serviceability (RAS) operations across device transitions.

In some examples, the management controller may communicate with a CXL switching controller over an out-of-band network that is separate from a data network of the host system. The out-of-band network may be a dedicated communication channel used exclusively for platform management operations and may be physically or logically distinct from the main data path through which the host system exchanges application and user data. The out-of-band network may enable the transmission of requests and error records between the management controller and the CXL switch independently of the host operating system or processor state. For instance, the request to retrieve the error record associated with a CXL device may be transmitted via the out-of-band network, by passing the primary data interfaces. Similarly, after the management controller retrieves the error record using the firmware routine, the error record may be sent back to the switch through this same out-of-band path.

The out-of-band network may comprise, for example, a dedicated Ethernet link, a physically isolated management VLAN, or a serial channel interfaced through a baseboard management controller (BMC). By contrast, the data network of the host system may include PCIe links, memory interconnects, or general-purpose network interfaces such as standard Ethernet ports used for normal runtime traffic and application-level data exchange. These data paths may become unavailable when the host is unresponsive, in a pre-boot state, or if the CXL device has been logically unbound.

Using the out-of-band network for transmitting control requests and error records ensures robust and persistent communication between the management controller and the switching controller. It allows for the continuation of essential platform diagnostics and reassignment procedures even if the primary data network is disrupted or unavailable. This separation enhances system resilience, enables clean error record handoff across host transitions, and reinforces security and isolation between control plane and data plane operations.

The described management controller 200 may enable a reliable and OS-independent mechanism for retrieving platform error records associated with a CXL device during device reassignment workflows. By receiving a retrieval request from a CXL switch and autonomously triggering a firmware routine to obtain the error record of a CXL device that was previously bound to the host, the management controller ensures that diagnostic and fault-related information is preserved and made available for downstream analysis before the device is reassigned. This architecture enhances platform-level fault awareness, facilitates safe CXL device transitions across hosts, and supports robust Reliability, Availability, and Serviceability (RAS) procedures, even when the host operating system is inactive, or the device is no longer logically connected.

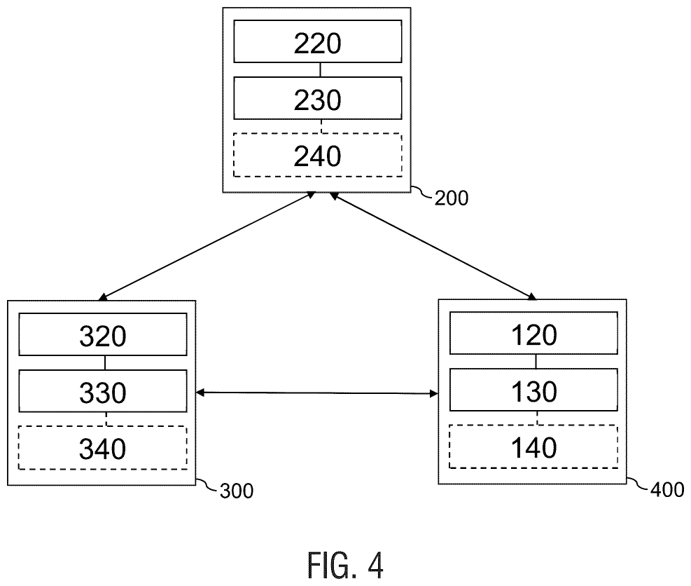

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-12).

FIG. 3 illustrates a block diagram of an example of an management controller 300 or device 300. The management controller 300 comprises circuitry that is configured to provide the functionality of the management controller 300. For example, the management controller 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the management controller 300, in conjunction with the interface circuitry 320. For example, the interface circuitry 320 is configured to exchange information, e.g., with other components inside or outside the management controller 300 and the storage circuitry 340. Likewise, the device 300 may comprise means that is/are configured to provide the functionality of the device 300.

The components of the device 300 are defined as component means, which may correspond to, or implemented by, the respective structural components of the management controller 300. For example, the device 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the management controller 300. Features described in connection with the management controller 300 may thus likewise be applied to the corresponding device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The management controller 300 or device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 330 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 330 is configured to receive, from a CXL switch, a request to store an error record of a CXL device to be bound to a host corresponding to the management controller. The management controller 300 may be part of the host. In some examples, the management controller 300 may be a control component of the host, where the host is configured to interface with the CXL device. The management controller 300 may be implemented as a hardware-based subsystem, such as a BMC, or as a functionally equivalent system control module embedded on the host. The management controller 300 may operate independently of the host's operating system and main processor cores, and may be configured to perform platform-level functions such as initiating firmware routines, retrieving and storing diagnostic data, or handling out-of-band communication. The management controller 300 may be the second management controller of the second host as described above with regards to FIG. 1

For example, the host may be a computing system or processing platform configured to interface with one or more CXL devices via a CXL-compatible interconnect. The host system associated with the management controller may include processing circuitry, memory resources, platform firmware, and one or more CXL interfaces. The host may be operable to bind to and interact with a CXL device via a CXL switch (for example, the apparatus 100 as described with regards to FIG. 1). The CXL switch may comprise interface circuitry configured to maintain physical and logical connectivity with the CXL device and with a plurality of hosts, including the host corresponding to the management controller. The switch may manage the reassignment of the CXL device between the host and another host, and may initiate coordination steps such as requesting retrieval of an error record from the host before assigning the CXL device to the second host

For example, the host may be a computing system or processing platform configured to interface with one or more CXL devices via a CXL-compatible interconnect. The host system associated with the second management controller may include processing circuitry, memory resources, platform firmware, and one or more CXL interfaces. The host may be operable to bind to and interact with a CXL device via a CXL switch (for example, the apparatus 100 as described with regard to FIG. 1). The CXL switch may comprise interface circuitry configured to maintain physical and logical connectivity with the CXL device and with a plurality of hosts, including the host corresponding to the second management controller. The switch may manage the reassignment of the CXL device between hosts, and may initiate coordination steps such as transmitting a request to the second management controller to store an error record of the CXL device before assigning the CXL device to the new host.

The error record may be a structured diagnostic object formatted, for example, according to the Common Platform Error Record (CPER) specification and may contain metadata describing a fault condition of the CXL device during its operational period under the first host. The record may have been retrieved from firmware-managed memory of another host (for example the first host see FIG. 1 and FIG. 2) using a platform firmware runtime handler. By forwarding this record to the second management controller, the CXL switch enables the new host to retain critical fault context and support Reliability, Availability, and Serviceability (RAS) procedures.

In some examples, the request to store the error record may comprise the error record. That is, the request to store the error record may comprise the error record itself as part of the transmitted message. That is, the CXL switch may embed the error record directly within the request payload sent to the management controller. This allows the management controller to receive all necessary diagnostic data in a single step, enabling immediate storage into firmware-managed memory without requiring a separate retrieval phase. This integration streamlines the reassignment workflow and reduces communication overhead between components.

The request may indicate that the error record pertains to the CXL device that is to be bound to the host. That is, the CXL device may already be physically connected to the switch but not yet logically assigned (bound) to the host. The host may be to be bound referring to a transitional state in which the CXL device is not yet logically assigned to the second host but is scheduled for binding as part of a reassignment process. At this stage, physical connectivity to the second host may already exist (for example, via the switch's upstream and downstream interfaces) but logical connectivity has not yet been established through the switch's internal routing structures such as a virtual PCI-to-PCI bridge (VPPB). No device enumeration or configuration by the host may have occurred. However, preparatory steps may already be underway, such as transmission of the error record, verification of host readiness, or allocation of routing resources, indicating that binding is imminent and contingent upon successful completion of such steps.

Binding the CXL device refers to the configuration of the internal routing within the switch to establish a logical communication path from the downstream interface associated with the CXL device to the upstream interface of the second host. For example, this may be done via a virtual PCI-to-PCI bridge (VPPB). The logical binding may enable the host to enumerate the CXL device in its PCIe hierarchy and initiate transactions under CXL.io, CXL.mem, or CXL.cache protocols. However, to ensure safe and consistent device behavior, this binding may be deferred until the error record has been securely stored by the second management controller. This sequence enforces fault awareness continuity during reassignment and helps the second host to apply appropriate validation or quarantine measures before enabling full device access.

The processing circuitry 330 is further configured to store the error record in firmware-managed memory of the host. The firmware-managed memory may refer to a region of non-volatile memory (NVM) that is directly controlled by the host's platform firmware, rather than by its operating system or user applications. The storage of the error record in such a memory may ensure persistent, secure, and OS-independent retention of diagnostic data, allowing the second host to access the record during boot, runtime, or post-mortem analysis.

In some examples, storing the error record may comprise invoking a firmware routine of the host, the firmware routine being configured to write the error record using platform firmware runtime services. The firmware routine may be implemented as a platform runtime handler, which is capable of executing within a privileged firmware environment such as the Unified Extensible Firmware Interface (UEFI) runtime phase or System Management Mode (SMM). The invocation of the platform runtime handler may occur independently of the host operating system, thereby enabling access to secure and persistent storage resources even when the operating system is offline or unavailable. For example, the platform runtime handler may be triggered by the management controller through a general-purpose input/output (GPIO) signal, which initiates an ACPI-defined platform event that activates the execution of the firmware routine.

The platform runtime handler may be specifically configured to write diagnostic records and platform-level variables to a non-volatile memory region under firmware control. For instance, the firmware routine may call the UEFI runtime function SetVariable( ) to store the error record in a designated memory segment reserved for firmware-managed variables. The memory region used for this purpose may be implemented using non-volatile random-access memory (NVRAM), an electrically erasable programmable read-only memory (EEPROM), or other persistent memory technologies designed to retain data across system resets, power cycles, or host reassignments. Because the platform runtime handler operates within a trusted execution context, the integrity and authenticity of the stored error data is maintained.

The use of a platform runtime handler for storage of the error record ensures that the diagnostic state of the CXL device is preserved in a secure and structured format. This mechanism may enable that platform-level fault information is retained independently of the runtime environment of the host and is available for future retrieval by firmware services, system administrators, or orchestration layers managing CXL device reassignments. Importantly, the error record is insulated from interference or deletion by application-level software, providing a level of trust and consistency critical for Reliability, Availability, and Serviceability (RAS) operations in enterprise and cloud deployments.

By committing the error record to a firmware-managed, non-volatile memory location, the host platform is enabled to access comprehensive and trustworthy diagnostic history during subsequent phases of device initialization, pre-boot validation, or reassignment workflows.

The stored error record may be used to determine whether the CXL device should be enabled for normal operation, placed into quarantine, subjected to additional diagnostics, or withheld from use altogether. This capability contributes to enhanced platform resilience, predictable fault handling, and continuity of operational safety across dynamic multi-host environments where CXL devices may be reassigned between different host systems.

The processing circuitry 330 is further configured to transmit a confirmation to the CXL switch indicating successful storage of the error record. The confirmation may serve as a platform-level acknowledgment that the error record, previously retrieved from another host, has been successfully and persistently stored in the firmware-managed memory of the host. This confirmation may act as a prerequisite condition for the CXL switch to proceed with subsequent actions, such as binding the CXL device to the host or enabling further platform configuration steps.

In some examples, the confirmation indicating successful storage may be generated in response to a return status from the firmware routine. The firmware routine may be invoked for writing the error record. The return status may signal whether the storage operation—for example carried out through a platform runtime handler using a function such as SetVariable( )—completed successfully or encountered an error. A successful return status may confirm that the error record has been written into a designated non-volatile memory region, such as NVRAM or EEPROM, and is thus reliably preserved across system reboots and power cycles. Upon receipt of this return status, the processing circuitry 330 may construct and transmit a confirmation message back to the CXL switch to inform it that the platform state has been securely updated.

The confirmation may include metadata such as a success indicator, a timestamp, or an identifier of the stored record to allow the CXL switch to validate the operation and proceed with logically binding the CXL device to the current host. This controlled and explicit feedback mechanism enhances the robustness of the CXL reassignment architecture by tightly coupling critical state transitions (such as rebinding of the device) to the verified completion of safety-critical actions like error record persistence.

At the end of the reassignment process, the host may be logically bound to the CXL device by the CXL switch. Binding may comprise establishing a new logical association between the host and the CXL device within the switching fabric, for example by configuring a virtual PCI-to-PCI bridge (VPPB) or other reconfigurable routing structure. This logical connection enables the host to enumerate and access the CXL device over the already existing physical link. The binding may occur only after the switch has received confirmation that the error record has been successfully stored, ensuring that platform-level fault awareness is preserved before device ownership is transferred.

In some examples, management controller may communicate with the CXL switch over an out-of-band network that is physically or logically separated from a data network of the host. In some examples, management controller may communicate with the CXL switch over an out-of-band network that is physically or logically separated from a data network of the second host. This channel may be used to transmit the request to store the error record (from the CXL switch to the management controller) and to return the confirmation indicating successful storage (from the management controller to the CXL switch). The out-of-band channel may be implemented using a physically isolated Ethernet link, a management VLAN, or a serial interface through a baseboard management controller (BMC). Communications between the CXL switch and the second management controller may be carried over this out-of-band interface.

The management controller 300 may enable a secure mechanism for storing platform-level diagnostic information during CXL device reassignment. By receiving a storage request from a CXL switch and writing the corresponding error record into firmware-managed memory of the host, the management controller ensures that critical fault data is preserved before the CXL device is logically assigned to the host. This architecture allows the host system to access trusted error information as part of pre-boot diagnostics or RAS (Reliability, Availability, and Serviceability) workflows, without relying on runtime software or device-resident state. By isolating this functionality in a management controller operating over an out-of-band channel, the system provides a robust fallback path for ensuring diagnostic continuity even when the main data path or host OS is unavailable. This contributes to overall system resilience, error transparency, and safer host-device transitions in dynamic, shared CXL environments.

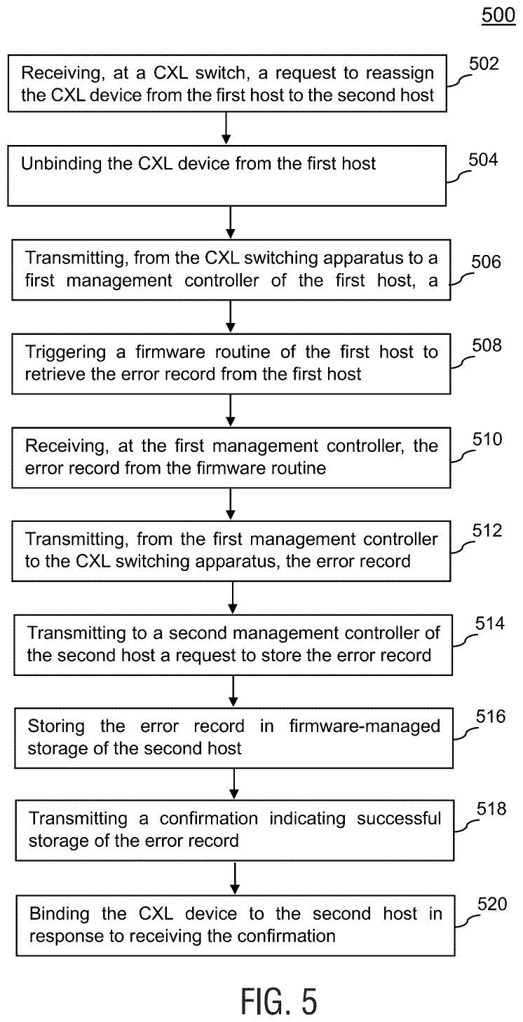

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-12).

FIG. 4 illustrates an example of a system 400. System 400 comprise apparatus 100 (see FIG. 1), management controller 200 (see FIG. 2) and management controller 300 (see FIG. 3). Apparatuses 100, 200 and 300 may be coupled communicatively, for example via their respective interface circuitry. Apparatus 100 may be configured as described above with regards to FIG. 1. Management controller 200 may be configured as described above with regards to FIG. 2. Management controller 300 may be configured as described above with regards to FIG. 3.

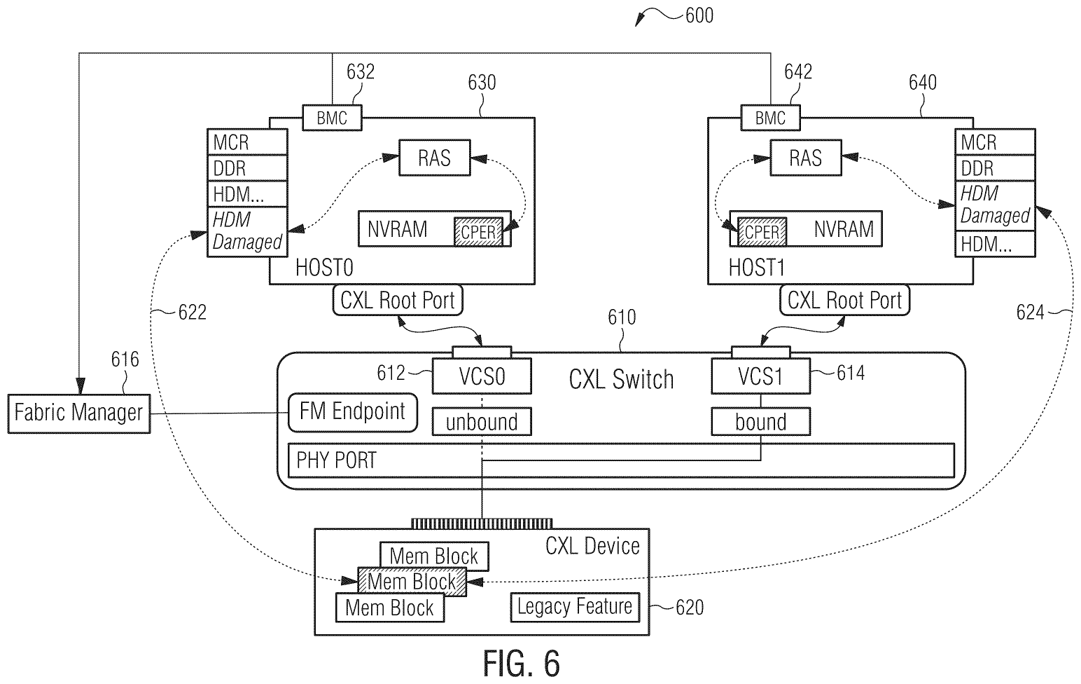

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-12).

FIG. 5 illustrates a flowchart of an example of a method 500. The method 500 may, for instance, be performed by one or more apparatuses as described herein, such as apparatus 100, management controller 200 and/or management controller 300. The method 500 comprises receiving 502, at a CXL switch (for example apparatus 100), a request to reassign the CXL device from the first host to the second host. The method 500 further comprises unbinding 504 the CXL device from the first host. The method 500 further comprises transmitting 506, from the CXL switching apparatus to a first management controller (for example apparatus 200) of the first host, a request to retrieve an error record associated with the CXL device. The method 500 further comprises triggering 508, by the first management controller, a firmware routine of the first host to retrieve the error record from firmware-managed storage of the first host. The method 500 further comprises receiving 510, at the first management controller, the error record from the firmware routine. The method 500 further comprises transmitting 512, from the first management controller to the CXL switching apparatus, the error record. The method 500 further comprises transmitting 514, from the CXL switching apparatus to a second management controller (for example apparatus 300) of the second host, a request to store the error record. The method 500 further comprises storing 516, by the second management controller, the error record in firmware-managed storage of the second host. The method 500 further comprises transmitting 518, from the second management controller to the CXL switching apparatus, a confirmation indicating successful storage of the error record. The method 500 further comprises binding 520 the CXL device to the second host in response to receiving the confirmation.

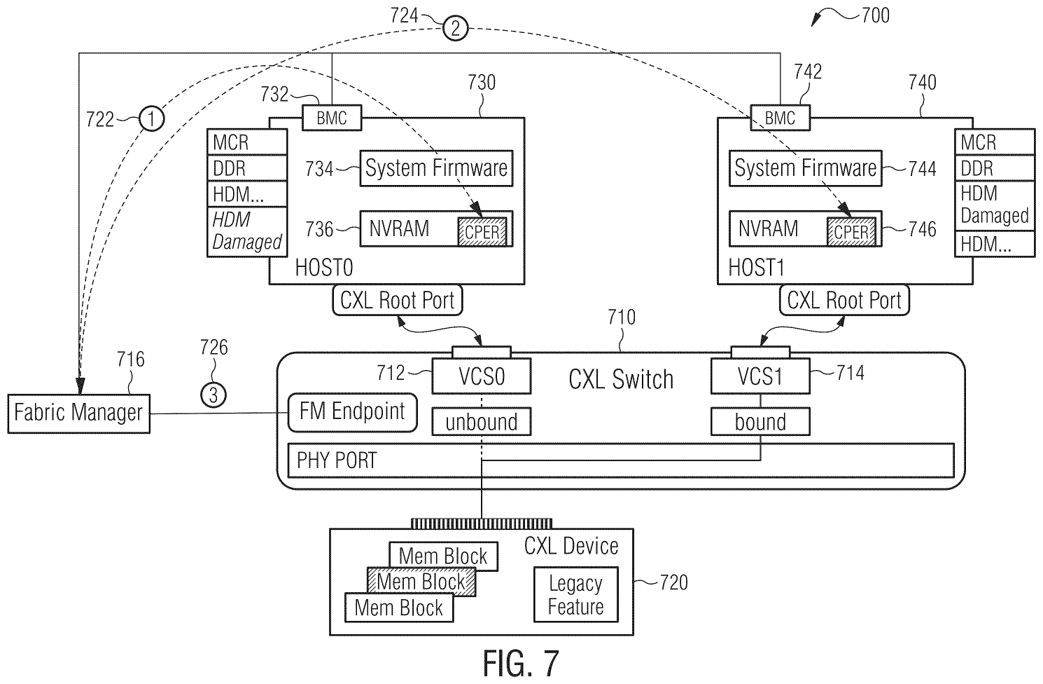

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-12).

FIG. 6 illustrates a block diagram of an example system 600 for reassignment of a CXL device. The system 600 comprises a CXL switch 610 with a and a Fabric Manager 616, a first host system (first host 730), a second host system (second host 740), and a CXL device 620. The CXL switch 610 includes a first virtual component slot (VCS0) 612 and a second virtual component slot (VCS1) 614, each configured to maintain logical assignment information for corresponding hosts. The CXL switch 610 is connected to the CXL device 620 through a downstream interface and to the first host 630 and second host 6640 through respective upstream interfaces. The CXL switch 610 may be configured to implement reconfigurable interconnect elements such as virtual PCI-to-PCI bridges (VPPBs) to establish logical host-device bindings. The CXL switch 610 may receive control instructions from the Fabric Manager 616 which may be part of the CXL switch 610, for example, to reassign the CXL device 620 from first host 730 to second host 740.

The first and the second host 630, 640 each comprise a platform management controller (BMC) 632, 642, platform firmware with Reliability, Availability, and Serviceability (RAS) logic 630, 640, and a non-volatile memory (NVRAM) containing firmware-managed storage regions.

The CXL device 620 may be connected to the first host 630. The CXL device 620 may comprise a plurality of memory blocks and may represent a memory expansion device that supports CXL protocols. The CXL device 620 may during this connection to the first host 630 encounter a fault condition, such as a memory damage. This condition may trigger an error reporting sequence while the device is assigned to the first host 630. In the context of firmware-first error handling, when the fault occurs on the CXL device 620 while it is bound to the first host 630, the host firmware may receive a Vendor Defined Message (VDM) via a CXL Event Firmware Notification (EFN). This VDM may be processed by the platform's System Control Interrupt (SCI) or System Management Interrupt (SMI), triggering the execution of BIOS-level error handling logic. Using mechanisms such as the ACPI Platform Error Interface (APEI) and the Hardware Error Source Table (HEST), the platform firmware may generate and store a Common Platform Error Record (CPER) entry in firmware-managed memory of the first host 630. The CPER-stored error record remains associated with the first host 630.

Now the Fabric Manager 616 may reassign the CXL device 620 from the first host 630 to the second host 340 by unbinding the VPPB in VCS0 and instantiating a new logical association in VCS1. The error record in this case may not automatically be available to the second host 640. Consequently, the reassigned CXL device may be perceived as fault-free by the second host 640. This lack of diagnostic continuity may result in the second host 640 skipping RAS validation steps, potentially leading to failure scenarios including repeated faults or uncorrectable errors (UCEs) during operation.

The CXL device's operational history, such as the critical fault context, may in in system 600 be decoupled from the physical component itself and instead remains bound to the original host's platform firmware.

The approach of FIG. 6 may rely on the robustness of the RAS features. It may be required that the CXL device 620 error to be re-processed every time after CXL device 620 is switching between hosts—even if it has already been processed on the previous host. To handle the CXL device errors, the system may enter the SMM mode to call RAS handler and deal with the error, which may have high-latency and may be complex to have a crash risk.

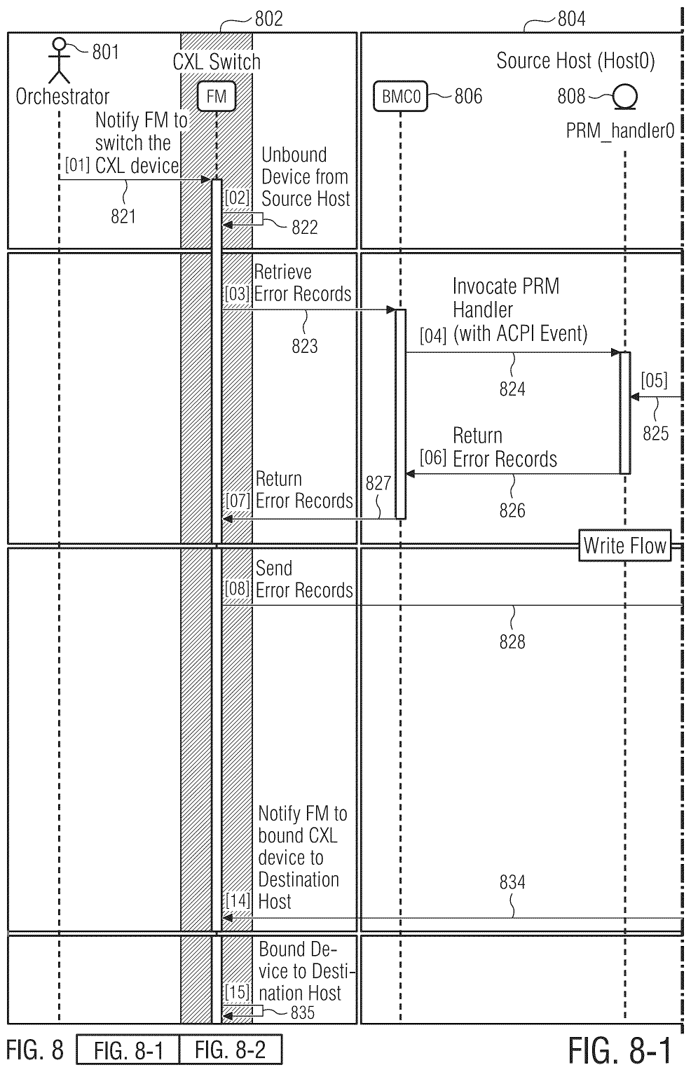

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-12).

FIG. 7 illustrates a block diagram of an example system 700 for reassignment of a CXL device supporting CXL Device error forwarding. The system 700 comprises a CXL switch, a first host system (first host 730), a second host system (second host 740), a CXL device comprising a Fabric Manager component. The CXL switch 710 comprises multiple Virtual Component Slots (VCS0, VCS1) for managing logical assignments between the CXL device and connected hosts. The first host 730 and the second host 740 each include platform firmware with 734, 744 persistent firmware-managed storage (e.g., NVRAM) 736, 746, where CPER-formatted error records may be maintained. Both host systems also contain a management controller (BMC) 732, 742, system firmware, and root ports connected to the CXL switch.

The CXL device 720 may comprise one or more memory blocks. During operation while assigned to first host 730, the CXL device may have encountered a hardware error, for example a corrupted memory block. In response, the firmware of first host 730 may have generated and stored a Common Platform Error Record (CPER) into a firmware-managed, non-volatile memory (NVRAM) region. This error record may describe the nature and location of the fault and may be preserved independently of host software. In order to avoid data loss or safety violations when reassigning the CXL device from the first host 730 to the second host 740, the fabric manger 716 of the CXL switch 710 performs an intermediate error record forwarding process In a first step 722, the Fabric Manager 716 initiates a retrieval operation for the error record from first host 730. This may be performed via an out-of-band request to the BMC 732 of first host 730, which in turn triggers a platform firmware routine to access the CPER-formatted error record from firmware-managed memory.

In a second step 724, the Fabric Manager 716 forwards the retrieved error record to the second host 740. This transfer may again occur through an out-of-band network and may involve the BMC 742 of second host 740 invoking a corresponding platform runtime routine to store the error record in the firmware-managed memory 746 of second host 740. This ensures that second host 740 receives the diagnostic context of the CXL device before the device is logically assigned. Only after the error record has been successfully received and stored on second host 740, the CXL switch proceeds with a third step 726, in which the CXL device 720 is reassigned from first host 730 to second host 740. This reassignment may be performed by modifying the logical connection via reconfigurable interconnect elements—e.g., by unbinding the virtual PCI-to-PCI bridge in VCS0 and establishing a new binding in VCS1.

This procedure may address the challenge of ensuring platform-level fault continuity in multi-host environments. By introducing the two preparatory steps retrieving 722 and writing 724 the error record before switching the device, the system 700 ensures that the CXL device's error state is preserved across host boundaries, thereby reducing the risk of silent failures and enhancing platform reliability and fault containment. This proactive transfer prevents second host 740 from unnecessarily re-triggering the RAS flow for known errors and avoids the risks associated with uncorrectable errors (UCEs). Furthermore, this error record pre-synchronization mechanism may better ensure seamless service switching and reduce service down time.

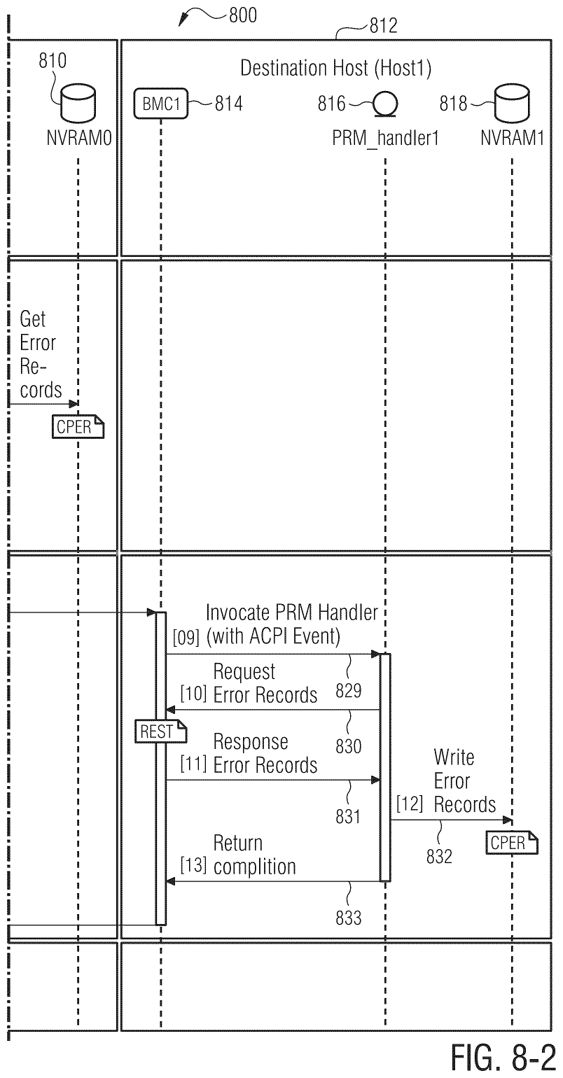

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIGS. 8-12).

FIG. 8 illustrates an example of a flowchart 800 of supporting CXL Device Error Forwarding (CDEF) during reassignment of a CXL device between host. The process 800 involves interactions among an orchestrator 801, a CXL switch 802 comprising a Fabric Manager (FM), a first host/source host 804 (HOST0), and a second host/destination host 812 (HOST1). Each host includes a Baseboard Management Controller (BMC), 806, 814 for, as well as platform runtime handlers 808, 816 and firmware-managed non-volatile memory (NVRAM) regions 810, 818 for storing error records in CPER format.

In step 821, the orchestrator notifies the Fabric Manager of the CXL switch 802 to reassign a CXL device from the source host 804 to the destination host 812 according to a scheduled workload. In step 822, the Fabric Manager 802 unbinds the CXL device from the VPPB (virtual PCI-to-PCI Bridge) associated with the source host 804, placing the device in an unbound state. In step 823, the Fabric Manager 802 initiates retrieval of the error records associated with the CXL device from BMC0 806 of the source host 804.

In step 824, BMC0 806 triggers an ACPI event to invoke a firmware handler (PRM_handler0) on the first host 804. In step 825, PRM_handler0 808 uses UEFI runtime services (for example, GetVariable( ) to retrieve the CPER-formatted error record from the NVRAM 810. In step 826, PRM_handler0 808 returns the error record to BMC0 806 via an IPMI command. In step 827, BMC0 806 returns the error record to the Fabric Manager 802 via the management network. In step 828, the Fabric Manager 802 forwards the error record to BMC1 814 of the destination host 812. In step 829, BMC1 814 triggers an ACPI event to invoke PRM_handler1 816 on the second host 812. In step 830, PRM_handler1 816 sends a REST request to BMC1 814 for the error record. In step 831, BMC1 814 responds to the REST request with the error record.

In step 832, PRM_handler1 816 writes the error record to firmware-managed memory 818 of the second host 812 using UEFI runtime services (for example, SetVariable( )). In step 833, PRM_handler1 816 signals completion of the write operation to BMC1 814 via IPMI.In step 834, BMC1 814 notifies the Fabric Manager 802 that the error record has been successfully stored and that the device is ready for reassignment. In step 835, the Fabric Manager 802 completes the reassignment by binding the CXL device to second host 812 through creation of a new VPPB entry in the CXL switch.

The process 800 ensures that the CPER-formatted error record generated while the CXL device was assigned to the first host 804 is securely transferred to the second host 812 before reassignment is finalized. This proactive transfer prevents the second host 812 from unnecessarily re-triggering the RAS flow for known errors and avoids the risks associated with UCEs. This error records pre-synchronization mechanism can better ensure seamless service switching and reduce service down time.

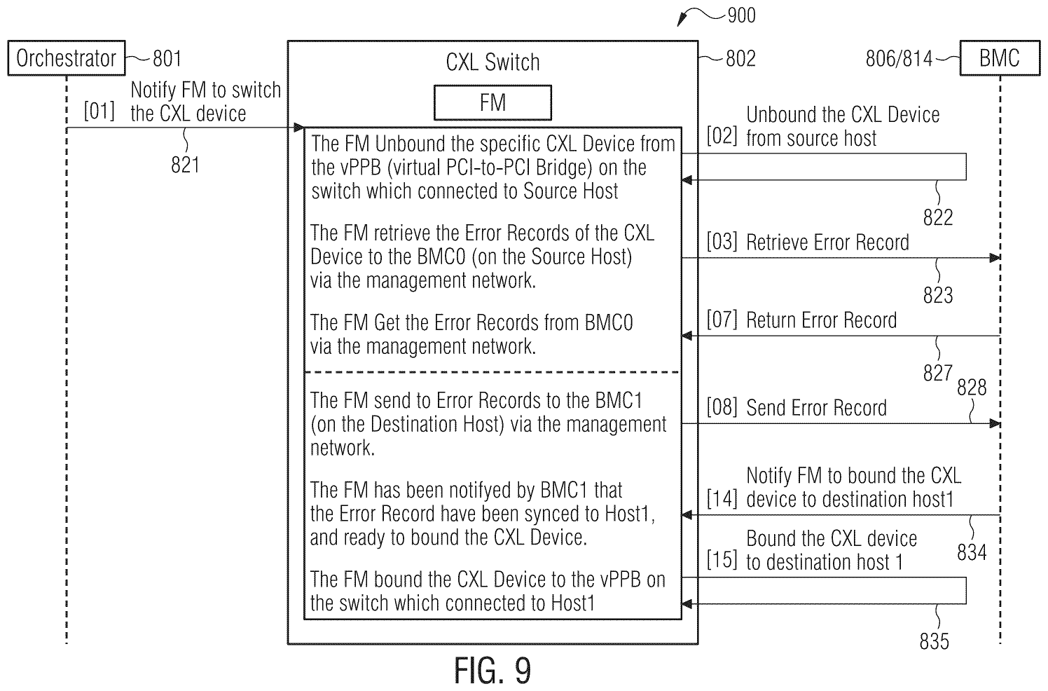

Further details and aspects are mentioned in connection with the examples described above or below. The example shown in FIG. 8 may include one or more optional additional features corresponding to one or more aspects mentioned in connection with the proposed concept or one or more examples described above (e.g., FIGS. 1-7) or below (e.g., FIGS. 9-12).

FIG. 9 illustrates an example of a flowchart 900 of interactions of a CXL switch during the CXL Device Error Forwarding (CDEF). The system includes the orchestrator 801, the CXL switch 802 comprising the Fabric Manager (FM), and the BMCs 806/814 acting on behalf of the first and second hosts. The steps and components are consistent with the steps and components as described in process 800 of FIG. 8. FIG. 8 focuses on the role of the Fabric Manager 802 of the CXL switch in orchestrating the secure and structured handoff of fault information prior to reassignment of a CXL device. By ensuring the CPER-formatted error record is successfully transferred and acknowledged before initiating rebinding, the FM 802 enables safe and RAS-compliant transitions of shared CXL resources between hosts.

In step 821, the orchestrator 801 notifies the Fabric Manager to initiate a reassignment of a specific CXL device from the source host to the destination host, for example based on a scheduled workload or resource allocation policy. In response, the Fabric Manager 802 initiates the error forwarding sequence as follows: In step 822, the FM 802 unbinds the specific CXL device from the virtual PCI-to-PCI bridge (VPPB) on the CXL switch that connects the device to the source host 804. This action places the device in an unbound state, which logically detaches it from the source host's PCIe hierarchy while retaining its physical connection. In step 823, the FM 802 retrieves the error records of the CXL device by sending a request to BMC0 806 of the source host 804 via the management network. The FM action includes the following sequence of operations: The FM Unbound the specific CXL Device from the vPPB (virtual PCI-to-PCI Bridge) on the switch which connected to Source Host. The FM retrieve the Error Records of the CXL Device to the BMC0 (on the Source Host) via the management network. The FM Get the Error Records from BMC0 via the management network.

In step 827, the FM 802 receives the error record returned from BMC0. Once retrieved, in step 828, the FM 802 forwards the error record to BMC1 814 on the destination host 812 using the out-of-band management network. Further, the FM 802 send to Error Records to the BMC1 (on the Destination Host) via the management network. After BMC1 has successfully stored the error record in firmware-managed memory using a platform runtime handler (see also step 832 in FIG. 8), it returns a completion notification to the FM 802. In step 834, the FM is notified by BMC1 that the error record has been synchronized to Host1 and that the CXL device is ready for reassignment. The FM 802 has been notified by BMC1 that the Error Record have been synced to Host1, and ready to bound the CXL Device.

In step 835, the FM finalizes the reassignment by binding the CXL device to second host 812. This may include instantiating a new virtual PCI-to-PCI bridge (VPPB) between the CXL device and the destination host within the CXL switch. The FM bound the CXL Device to the vPPB on the switch which connected to Host1.

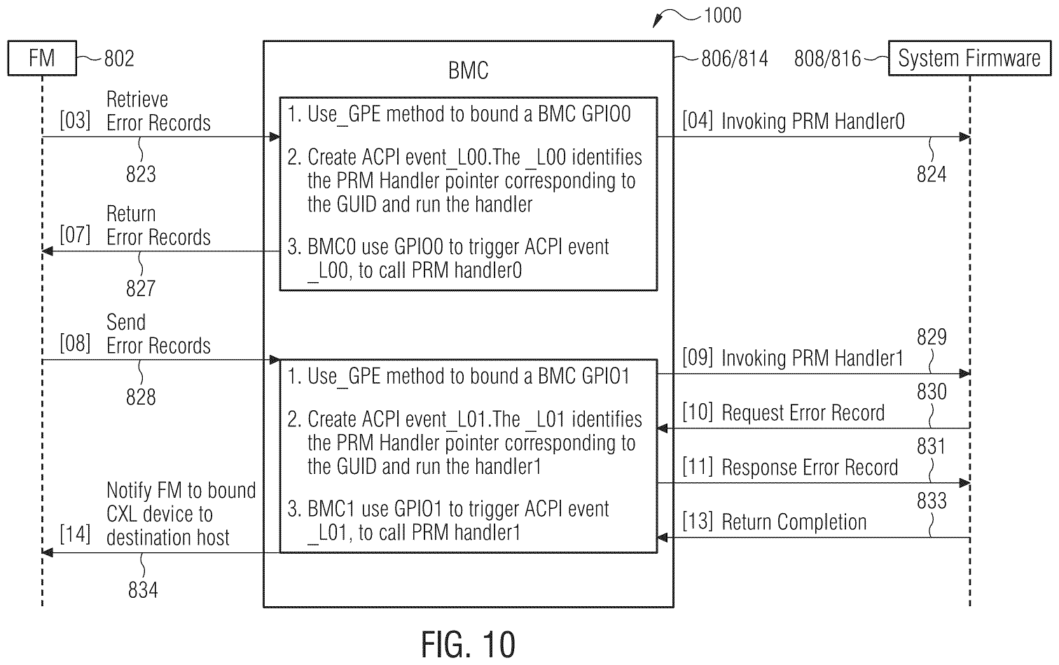

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1-8) or below (e.g., FIGS. 10-12).

FIG. 10 illustrates an example of a flowchart 1000 of interactions of BMC management controllers during the CXL Device Error Forwarding (CDEF). The diagram provides further technical detail for selected operations in process 800 of FIG. 8 and expands upon the responsibilities and internal signaling paths of the BMCs 806/814 during the CXL Device Error Forwarding (CDEF) workflow.

In step 823, the Fabric Manager 802 retrieves the error record associated with the CXL device from the BMC 806 of the first host by issuing a request over a management network. To fulfill this request, the BMC0 806 performs several platform-level actions. First, the BMC0 uses the _GPE method to bind the GPIO0 line, enabling system-level signaling. Then, the BMC0 806 creates an ACPI event named _L00. This event _L00 identifies the PRM handler pointer in the firmware, corresponding to a globally unique identifier (GUID), and facilitates firmware-level execution. Finally, the BMC0 806 uses the bound GPIO0 to trigger the ACPI event _L00 and thereby invoke the platform runtime handler PRM_handler0 on the first host system (step 824).

The PRM_handler0 then retrieves the error record, for example using UEFI runtime services such as GetVariable( ) and returns the CPER-formatted error record back to the BMC0 via an IPMI interface. The BMC subsequently returns the error record to the Fabric Manager in step 827.

In step 828, the Fabric Manager 802 forwards the retrieved error record to the BMC1 814 of the second host system via the management network. To process this error record and write it into the firmware-managed memory of the second host, BMC1 814 performs similar signaling as described above. Specifically, the BMC1 uses the _GPE method to bind the GPIO1 line. Then, it creates an ACPI event named _L01. This event _L01 identifies the PRM handler pointer PRM_handler1, again by referencing a GUID. The BMC1 uses the GPIO1 line to trigger the ACPI event _L01, thereby invoking PRM_handler1 (step 829).

Upon invocation, in step 830, the PRM_handler1 sends a REST request to BMC1 to access the transferred error record. In response, in step 831, the BMC1 supplies the error record to the handler, which writes it to a firmware-managed, non-volatile memory region using UEFI runtime services, for example via SetVariable( ) Once completed, in step [833], the PRM_handler1 sends a write completion signal back to BMC1, again via IPMI.

Finally, in step 834, BMC1 notifies the Fabric Manager 802 that the error record has been successfully synchronized to the second host and that the CXL device is ready for reassignment. The confirmation allows the Fabric Manager to proceed with rebinding the CXL device.

This figure highlights the responsibilities and roles (R&R) of the BMCs in enabling secure and structured device error synchronization.

Further details and aspects are mentioned in connection with the examples described above or below. The example shown in FIG. 10 may include one or more optional additional features corresponding to one or more aspects mentioned in connection with the proposed concept or one or more examples described above (e.g., FIGS. 1-9) or below (e.g., FIGS. 10-12).

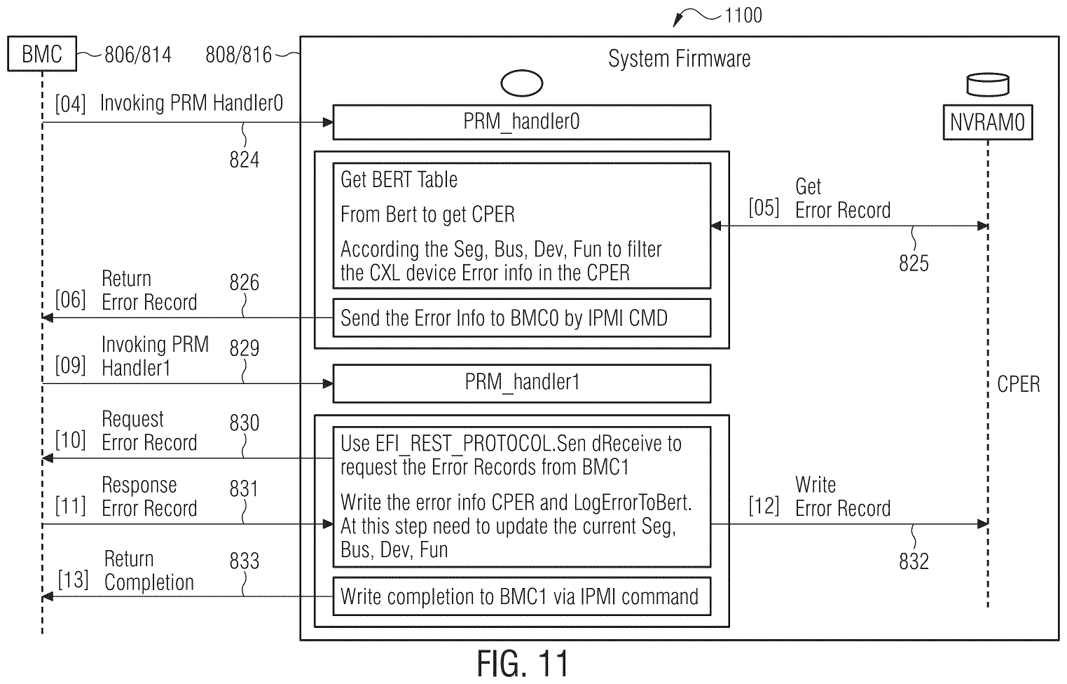

FIG. 11 illustrates an example of a flowchart 1100 of interactions system of firmware during the CXL Device Error Forwarding (CDEF). The interactions may comprise system firmware 808/816 of the source and destination host, and their respective Platform Runtime Handlers (PRM_handler0, PRM_handler1). The figure expands on the firmware execution paths initiated of process 800 shown in FIG. 8.

In step 824, PRM_handler0 of the source host 808 is invoked by BMC0 to retrieve the error record related to a specific CXL device. The platform firmware executes the following sequence internally: First, it accesses the Boot Error Record Table (BERT), from which it extracts the Common Platform Error Record (CPER). It then uses the Segment, Bus, Device, and Function (Seg, Bus, Dev, Fun) identifiers to filter the relevant CXL device-specific error information from the broader CPER content. Once the relevant section has been extracted, the error information is returned to BMC0 in step 826 via an IPMI command.

This logic illustrates the role of the BIOS (system firmware) on the source host in supporting the CDEF mechanism. The responsibilities of the BIOS in this stage comprise: registering and executing PRM_handler0, identifying the specific error record of the CXL device within the CPER, and transmitting the filtered data to the BMC0 over a control channel. These operations are referred to as the “BIOS R&R” of the source host.

In step 829, PRM_handler1 on the destination host is invoked by BMC1 to write the error record received from the Fabric Manager. In step 830, the PRM_handler1 uses EFI_REST_PROTOCOL. SendReceive to issue a REST request to BMC1 for the forwarded error record. In step 831, BMC1 responds with the error record. In step 832], PRM_handler1 writes the error record into the destination host's firmware-managed memory (e.g., NVRAM1) using CPER log entry creation and also logs the error to BERT. As part of this procedure, the firmware may update the current Seg, Bus, Dev, Fun values for accurate addressing. In step 833, PRM_handler1 returns a write completion message to BMC1 via IPMI.

This sequence represents the destination BIOS's responsibilities in the CDEF architecture. The BIOS registers and executes PRM_handler1, retrieves the error record using a REST protocol, writes it to CPER and logs it to BERT, and finally confirms completion to the BMC. These are the BIOS R&R responsibilities for the destination host.

The combined actions of PRM_handler0 and PRM_handler1 ensure that the CPER-formatted diagnostic context associated with the CXL device is accurately transferred and integrated across hosts during reassignment. By embedding error handling logic directly in platform firmware and decoupling it from the host operating system, the CDEF mechanism guarantees fault information integrity, runtime independence, and persistence across system boundaries.

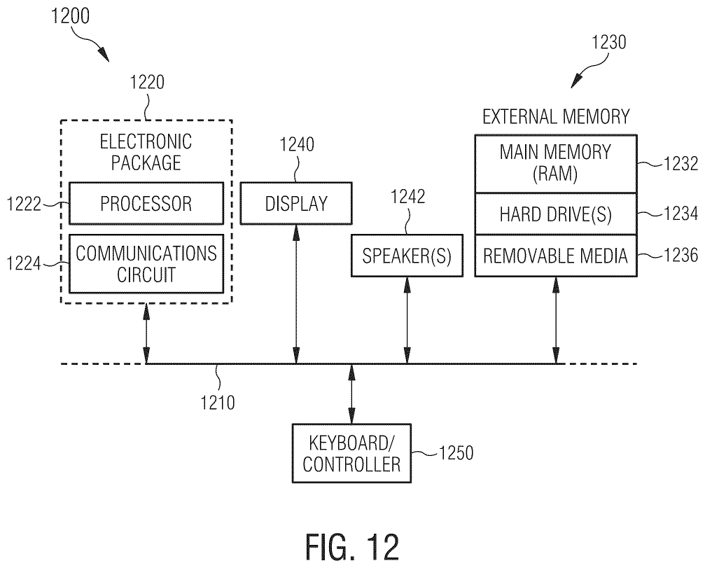

Further details and aspects are mentioned in connection with the examples described above or below. The example shown in FIG. 11 may include one or more optional additional features corresponding to one or more aspects mentioned in connection with the proposed concept or one or more examples described above (e.g., FIGS. 1-10) or below (e.g., FIG. 12).

FIG. 12 illustrates an example of a block diagram of an electronic apparatus 1200 incorporating at least one electronic assembly 100, 200, 300 and/or method 500 described herein. Electronic apparatus 1200 is-merely one example of an electronic apparatus in which forms of the electronic assemblies 100, 200, 300 and/or methods 500 described herein may be used. Examples of an electronic apparatus 1200 include, but are not limited to, personal computers, tablet computers, mobile telephones, game devices, MP3 or other digital music players, etc. In this example, electronic apparatus 1200 comprises a data processing system that includes a system bus 1210 to couple the various components of the electronic apparatus 1200. System bus 1210 provides communications links among the various components of the electronic apparatus 1200 and may be implemented as a single bus, as a combination of busses, or in any other suitable manner.

An electronic assembly 1220 as describe herein may be coupled to system bus 1210. The electronic assembly 1220 may include any circuit or combination of circuits. In one embodiment, the electronic assembly 1220 includes a processor 1222 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 1220 are a custom circuit, an application-specific integrated circuit (ASIC), or the like, such as, for example, one or more circuits (such as a communications circuit 1224) for use in wireless devices like mobile telephones, tablet computers, laptop computers, two-way radios, and similar electronic systems. The IC can perform any other type of function.

The electronic apparatus 1200 may also include an external memory 1230, which in turn may include one or more memory elements suitable to the particular application, such as a main memory 132 in the form of random access memory (RAM), one or more hard drives 1234, and/or one or more drives that handle removable media 1236 such as compact disks (CD), flash memory cards, digital video disk (DVD), and the like.

The electronic apparatus 1200 may also include a display device 1240, one or more speakers 1242, and a keyboard and/or controller 1250, which can include a mouse, trackball, touch screen, voice—recognition device, or any other device that permits a system user to input information into and receive information from the electronic apparatus 1200.

Further details and aspects are mentioned in connection with the examples described above. The example shown in FIG. 12 may include one or more optional additional features corresponding to one or more aspects mentioned in connection with the proposed concept or one or more examples described above (e.g., FIGS. 1-11).

In the following, some examples of the proposed concept are presented:

An example (e.g., example 1) relates to an apparatus comprising interface circuitry, machine-readable instructions and processing circuitry to execute the machine-readable instructions to receive a request to reassign a CXL device from a first host to a second host, transmit, to a first management controller of the first host, a request for retrieving an error record of the CXL device, receive, from the first management controller, the error record, transmit, to a second management controller of a second host, a request for storing the error record of the CXL device, and bind the CXL device to the second host after receiving a confirmation indicating successful storing of the error record at the second host.

Another example (e.g., example 2) relates to a previous example (e.g., example 1) or to any other example, further comprising that the processing circuitry is further to execute the machine-readable instructions to unbind the CXL device from the first host, wherein the request for retrieving the error record of the CXL device is transmitted to the first management controller of the first host after unbinding the CXL device.

Another example (e.g., example 3) relates to a previous example (e.g., one of the examples 1 to 2) or to any other example, further comprising that reassigning the CXL device from the first host to the second host comprises modifying a logical assignment from the first host to the second host via a reconfigurable interconnect element.

Another example (e.g., example 4) relates to a previous example (e.g., one of the examples 1 to 3) or to any other example, further comprising that the error record comprises information identifying a fault condition of the CXL device, the fault condition having occurred while the CXL device was bound to the first host.

Another example (e.g., example 5) relates to a previous example (e.g., one of the examples 1 to 4) or to any other example, further comprising that the error record is formatted according to a Common Platform Error Record, CPER, specification.

Another example (e.g., example 6) relates to a previous example (e.g., one of the examples 1 to 5) or to any other example, further comprising that the request to store the error record comprises the error record.

Another example (e.g., example 7) relates to a previous example (e.g., one of the examples 1 to 6) or to any other example, further comprising that the error record is retrieved by the first management controller by triggering a firmware handler of the first host.

Another example (e.g., example 8) relates to a previous example (e.g., one of the examples 1 to 7) or to any other example, further comprising that the error record is retrieved from a non-volatile memory of the first host using UEFI runtime services.

Another example (e.g., example 9) relates to a previous example (e.g., one of the examples 1 to 8) or to any other example, further comprising that the request to retrieve the error record is transmitted to first the management controller via an out-of-band network, wherein the out-of-band network is separate from a data network of the first host

Another example (e.g., example 10) relates to a previous example (e.g., one of the examples 1 to 9) or to any other example, further comprising that the request for storing the error record of the CXL device comprises a request to store the error record in firmware-managed storage of the second host.

Another example (e.g., example 11) relates to a previous example (e.g., one of the examples 1 to 10) or to any other example, further comprising that the confirmation indicating successful storage of the error record is received from the second management controller.

An example (e.g., example 12) relates to a management controller comprising interface circuitry, machine-readable instructions, and processing circuitry to execute the machine-readable instructions to receive, from a CXL switch, a request to retrieve an error record of a CXL device unbound from a host corresponding to the management controller, trigger a firmware routine of the host, the firmware routine being configured to obtain the error record of the CXL device, receive the error record from the firmware routine, and transmit the error record to a CXL switch.

Another example (e.g., example 13) relates to a previous example (e.g., example 12) or to any other example, further comprising that triggering the firmware routine comprises transmitting a trigger signal via a general-purpose input/output, GPIO, interface to cause the host system to initiate the firmware routine.

Another example (e.g., example 14) relates to a previous example (e.g., one of the examples 12 to 13) or to any other example, further comprising that the firmware routine comprises a platform runtime handler configured to use platform firmware runtime service to retrieve the error record from the firmware-managed storage.

Another example (e.g., example 15) relates to a previous example (e.g., one of the examples 12 to 14) or to any other example, further comprising that the error record is received from the firmware routine via an Intelligent Platform Management Interface, IPMI, communication channel.

Another example (e.g., example 16) relates to a previous example (e.g., one of the examples 12 to 15) or to any other example, further comprising that the error record is formatted according to a Common Platform Error Record, CPER, specification.

Another example (e.g., example 17) relates to a previous example (e.g., one of the examples 12 to 16) or to any other example, further comprising that the error record is stored in non-volatile memory managed by firmware of the host system and accessible via a firmware runtime interface.

Another example (e.g., example 18) relates to a previous example (e.g., one of the examples 12 to 17) or to any other example, further comprising that the management controller communicates with a CXL switch over an out-of-band network that is separate from a data network of the host system.

An example (e.g., example 19) relates to a management controller comprising interface circuitry, machine-readable instructions, and processing circuitry to execute the machine-readable instructions to receive, from a CXL switch, a request to store an error record of a CXL device to be bound to a host corresponding to the management controller, store the error record in firmware-managed memory of the host, and transmit a confirmation to the CXL switch indicating successful storage of the error record.

Another example (e.g., example 20) relates to a previous example (e.g., example 19) or to any other example, further comprising that storing the error record comprises invoking a firmware routine of the host to write the error record using platform firmware runtime service.

Another example (e.g., example 21) relates to a previous example (e.g., one of the examples 19 to 20) or to any other example, further comprising that the firmware routine is a platform runtime handler configured to store platform firmware variables in non-volatile memory.

Another example (e.g., example 22) relates to a previous example (e.g., example 21) or to any other example, further comprising that the confirmation indicating successful storage is generated in response to a return status from the firmware routine.

Another example (e.g., example 23) relates to a previous example (e.g., one of the examples 19 to 22) or to any other example, further comprising that the error record is stored in a format compliant with a Common Platform Error Record, CPER, specification.

Another example (e.g., example 24) relates to a previous example (e.g., one of the examples 19 to 23) or to any other example, further comprising that the management controller communicates with the CXL switch over an out-of-band network that is physically or logically separated from a data network of the host.

Another example (e.g., example 25) relates to a previous example (e.g., one of the examples 19 to 24) or to any other example, further comprising that the management controller requests to store the error record comprises the error record.

An example (e.g., example 26) relates to a system comprising a CXL switching apparatus according to a previous example (e.g., one of the examples 1 to 11), the first management controller according to any one of examples 12 to 18, the second management controller according to any one of examples 19 to 25.

An example (e.g., example 27) relates to a method comprising receiving, at a CXL switch, a request to reassign the CXL device from the first host to the second host, unbinding the CXL device from the first host, transmitting, from the CXL switching apparatus to a first management controller of the first host, a request to retrieve an error record associated with the CXL device, triggering, by the first management controller, a firmware routine of the first host to retrieve the error record from firmware-managed storage of the first host, receiving, at the first management controller, the error record from the firmware routine, transmitting, from the first management controller to the CXL switching apparatus, the error record, transmitting, from the CXL switching apparatus to a second management controller of the second host, a request to store the error record, storing, by the second management controller, the error record in firmware-managed storage of the second host, transmitting, from the second management controller to the CXL switching apparatus, a confirmation indicating successful storage of the error record, and binding the CXL device to the second host in response to receiving the confirmation.

An example (e.g., example 28) relates to a method comprising receiving a request to reassign a CXL device from a first host to a second host, transmitting, to a first management controller of the first host, a request for retrieving an error record of the CXL device, receiving, from the first management controller, the error record, transmitting, to a second management controller of a second host, a request for storing the error record of the CXL device, and binding the CXL device to the second host after receiving a confirmation indicating successful storing of the error record at the second host.

Another example (e.g., example 29) relates to a previous example (e.g., example 28) or to any other example, further comprising unbinding the CXL device from the first host, wherein the request for retrieving the error record of the CXL device is transmitted to the first management controller of the first host after unbinding the CXL device.

Another example (e.g., example 30) relates to a previous example (e.g., one of the examples 28 to 29) or to any other example, further comprising that reassigning the CXL device from the first host to the second host comprises modifying a logical assignment from the first host to the second host via a reconfigurable interconnect element.

Another example (e.g., example 31) relates to a previous example (e.g., one of the examples 28 to 30) or to any other example, further comprising that the error record comprises information identifying a fault condition of the CXL device, the fault condition having occurred while the CXL device was bound to the first host.

Another example (e.g., example 32) relates to a previous example (e.g., one of the examples 28 to 31) or to any other example, further comprising that the error record is formatted according to a Common Platform Error Record, CPER, specification.

Another example (e.g., example 33) relates to a previous example (e.g., one of the examples 28 to 32) or to any other example, further comprising that the request to store the error record comprises the error record.

Another example (e.g., example 34) relates to a previous example (e.g., one of the examples 28 to 33) or to any other example, further comprising that the error record is retrieved by the first management controller by triggering a firmware handler of the first host.

Another example (e.g., example 35) relates to a previous example (e.g., one of the examples 28 to 34) or to any other example, further comprising that the error record is retrieved from a non-volatile memory of the first host using UEFI runtime services.

Another example (e.g., example 36) relates to a previous example (e.g., one of the examples 25 to 35) or to any other example, further comprising that the request to retrieve the error record is transmitted to first the management controller via an out-of-band network, wherein the out-of-band network is separate from a data network of the first host

Another example (e.g., example 37) relates to a previous example (e.g., one of the examples 28 to 36) or to any other example, further comprising that the request for storing the error record of the CXL device comprises a request to store the error record in firmware-managed storage of the second host.

Another example (e.g., example 38) relates to a previous example (e.g., one of the examples 28 to 37) or to any other example, further comprising that the confirmation indicating successful storage of the error record is received from the second management controller.

An example (e.g., example 39) relates to a method comprising receiving, from a CXL switch, a request to retrieve an error record of a CXL device unbound from a host corresponding to the management controller, triggering a firmware routine of the host, the firmware routine being configured to obtain the error record of the CXL device, receiving the error record from the firmware routine, and transmitting the error record to a CXL switch.

Another example (e.g., example 40) relates to a previous example (e.g., example 39) or to any other example, further comprising that triggering the firmware routine comprises transmitting a trigger signal via a general-purpose input/output, GPIO, interface to cause the host system to initiate the firmware routine.

Another example (e.g., example 41) relates to a previous example (e.g., one of the examples 39 to 40) or to any other example, further comprising that the firmware routine comprises a platform runtime handler configured to use platform firmware runtime service to retrieve the error record from the firmware-managed storage.

Another example (e.g., example 42) relates to a previous example (e.g., one of the examples 39 to 41) or to any other example, further comprising that the error record is received from the firmware routine via an Intelligent Platform Management Interface, IPMI, communication channel.

Another example (e.g., example 43) relates to a previous example (e.g., one of the examples 39 to 42) or to any other example, further comprising that the error record is formatted according to a Common Platform Error Record, CPER, specification.

Another example (e.g., example 44) relates to a previous example (e.g., one of the examples 39 to 43) or to any other example, further comprising that the error record is stored in non-volatile memory managed by firmware of the host system and accessible via a firmware runtime interface.

Another example (e.g., example 45) relates to a previous example (e.g., one of the examples 39 to 44) or to any other example, further comprising that the management controller communicates with a CXL switch over an out-of-band network that is separate from a data network of the host system.

An example (e.g., example 46) relates to a method comprising receiving, from a CXL switch, a request to store an error record of a CXL device to be bound to a host corresponding to the management controller, storing the error record in firmware-managed memory of the host, and transmitting a confirmation to the CXL switch indicating successful storage of the error record.

Another example (e.g., example 47) relates to a previous example (e.g., example 46) or to any other example, further comprising that storing the error record comprises invoking a firmware routine of the host to write the error record using platform firmware runtime service.

Another example (e.g., example 48) relates to a previous example (e.g., one of the examples 46 to 47) or to any other example, further comprising that the firmware routine is a platform runtime handler configured to store platform firmware variables in non-volatile memory.

Another example (e.g., example 49) relates to a previous example (e.g., example 48) or to any other example, further comprising that the confirmation indicating successful storage is generated in response to a return status from the firmware routine.

Another example (e.g., example 50) relates to a previous example (e.g., one of the examples 46 to 49) or to any other example, further comprising that the error record is stored in a format compliant with a Common Platform Error Record, CPER, specification.

Another example (e.g., example 51) relates to a previous example (e.g., one of the examples 46 to 50) or to any other example, further comprising that the management controller communicates with the CXL switch over an out-of-band network that is physically or logically separated from a data network of the host.

Another example (e.g., example 52) relates to a previous example (e.g., one of the examples 46 to 51) or to any other example, further comprising that the request to store the error record comprises the error record.

Another example (e.g., example 53) relates to a non-transitory computer-readable medium storing instructions that, when executed by one or more processing circuitries, causing the one or more processing circuitries to perform a method according to a previous example (e.g., one of the examples 27, 28 to 38, 39 to 45 or 46 to 52).

An example (e.g., example 54) relates to an apparatus comprising a processor circuitry configured to receive a request to reassign a CXL device from a first host to a second host, transmit, to a first management controller of the first host, a request for retrieving an error record of the CXL device, receive, from the first management controller, the error record, transmit, to a second management controller of a second host, a request for storing the error record of the CXL device, and bind the CXL device to the second host after receiving a confirmation indicating successful storing of the error record at the second host.

An example (e.g., example 55) relates to an apparatus comprising a processor circuitry configured to receive, from a CXL switch, a request to retrieve an error record of a CXL device unbound from a host corresponding to the management controller, trigger a firmware routine of the host, the firmware routine being configured to obtain the error record of the CXL device, receive the error record from the firmware routine, and transmit the error record to a CXL switch.

An example (e.g., example 56) relates to an apparatus comprising a processor circuitry configured to receive, from a CXL switch, a request to store an error record of a CXL device to be bound to a host corresponding to the management controller, store the error record in firmware-managed memory of the host, and transmit a confirmation to the CXL switch indicating successful storage of the error record.

An example (e.g., example 57) relates to a device comprising means for processing for receiving a request to reassign a CXL device from a first host to a second host, transmitting, to a first management controller of the first host, a request for retrieving an error record of the CXL device, receiving, from the first management controller, the error record, transmitting, to a second management controller of a second host, a request for storing the error record of the CXL device, and binding the CXL device to the second host after receiving a confirmation indicating successful storing of the error record at the second host.

An example (e.g., example 58) relates to a device comprising means for processing for receiving, from a CXL switch, a request to retrieve an error record of a CXL device unbound from a host corresponding to the management controller, triggering a firmware routine of the host, the firmware routine being configured to obtain the error record of the CXL device, receiving the error record from the firmware routine, and transmitting the error record to a CXL switch.

An example (e.g., example 59) relates to a device comprising means for processing for receiving, from a CXL switch, a request to store an error record of a CXL device to be bound to a host corresponding to the management controller, storing the error record in firmware-managed memory of the host, and transmitting a confirmation to the CXL switch indicating successful storage of the error record.

Another example (e.g., example 60) relates to a computer program having a program code for performing a method according to a previous example (e.g., one of the examples 27, 28 to 38, 39 to 45 or 46 to 52) when the computer program is executed on a computer, a processor, or a programmable hardware component.

Another example (e.g., example 61) relates to machine-readable storage including machine readable instructions, when executed, to implement a method or realize an apparatus as described in any pending examples.

Another example (e.g., example 62) relates to computer-readable medium including program code, when executed, to cause a machine to perform a method according to a previous example (e.g., one of the examples 27, 28 to 38, 39 to 45 or 46 to 52).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
receive a request to reassign a CXL device from a first host to a second host;
transmit, to a first management controller of the first host, a request for retrieving an error record of the CXL device;
receive, from the first management controller, the error record;
transmit, to a second management controller of a second host, a request for storing the error record of the CXL device; and
bind the CXL device to the second host after receiving a confirmation indicating successful storing of the error record at the second host.

2. The apparatus of claim 1, wherein the processing circuitry is further to execute the machine-readable instructions to unbind the CXL device from the first host, wherein the request for retrieving the error record of the CXL device is transmitted to the first management controller of the first host after unbinding the CXL device.

3. The apparatus of claim 1, wherein reassigning the CXL device from the first host to the second host comprises modifying a logical assignment from the first host to the second host via a reconfigurable interconnect element.

4. The apparatus of claim 1, wherein the error record comprises information identifying a fault condition of the CXL device, the fault condition having occurred while the CXL device was bound to the first host.

5. The apparatus of claim 1, wherein the error record is formatted according to a Common Platform Error Record, CPER, specification.

6. The apparatus of claim 1, wherein the request to store the error record comprises the error record.

7. The apparatus of claim 1, wherein the error record is retrieved by the first management controller by triggering a firmware handler of the first host.

8. The apparatus of claim 1, wherein the error record is retrieved from a non-volatile memory of the first host using UEFI runtime services.

9. The apparatus of claim 1, wherein the request to retrieve the error record is transmitted to first the management controller via an out-of-band network, wherein the out-of-band network is separate from a data network of the first host.

10. The apparatus of claim 1, wherein the request for storing the error record of the CXL device comprises a request to store the error record in firmware-managed storage of the second host.

11. The apparatus of claim 1, wherein the confirmation indicating successful storage of the error record is received from the second management controller.

12. A management controller comprising interface circuitry, machine-readable instructions, and processing circuitry to execute the machine-readable instructions to:
receive, from a CXL switch, a request to retrieve an error record of a CXL device unbound from a host corresponding to the management controller;
trigger a firmware routine of the host, the firmware routine being configured to obtain the error record of the CXL device;
receive the error record from the firmware routine; and
transmit the error record to a CXL switch.

13. The management controller of claim 12, wherein triggering the firmware routine comprises transmitting a trigger signal via a general-purpose input/output, GPIO, interface to cause the host system to initiate the firmware routine.

14. The management controller of claim 12, wherein the firmware routine comprises a platform runtime handler configured to use platform firmware runtime service to retrieve the error record from the firmware-managed storage.

15. The management controller of claim 12, wherein the error record is received from the firmware routine via an Intelligent Platform Management Interface, IPMI, communication channel.

16. The management controller of claim 12, wherein the error record is stored in non-volatile memory managed by firmware of the host system and accessible via a firmware runtime interface.

17. A management controller comprising interface circuitry, machine-readable instructions, and processing circuitry to execute the machine-readable instructions to:
receive, from a CXL switch, a request to store an error record of a CXL device to be bound to a host corresponding to the management controller;
store the error record in firmware-managed memory of the host; and
transmit a confirmation to the CXL switch indicating successful storage of the error record.

18. The management controller of claim 17, wherein storing the error record comprises invoking a firmware routine of the host to write the error record using platform firmware runtime service.

19. The management controller of claim 17, wherein the firmware routine is a platform runtime handler configured to store platform firmware variables in non-volatile memory.

20. The management controller of claim 19, wherein the confirmation indicating successful storage is generated in response to a return status from the firmware routine.
